(19) United States
(12) Patent Application Publication
(10) Pub. No.: US 2018/0247248 A1
(43) Pub. Date: Aug. 30, 2018

(54) Measure Evaluation System and Measure Evaluation Method

(71) Applicant: Hitachi, Ltd., Chiyoda-ku, Tokyo (JP)

(72) Inventors: Wenpeng WEI, Tokyo (JP); Toshiko AIZONO, Tokyo (JP)

(21) Appl. No.: 15/758,235

(22) PCT Filed: Oct. 28, 2015
(86) PCT No.: PCT/JP2015/080313

§ 371 Date: Mar. 7, 2018

(51) Int. Cl. G06Q 10/06

(52) U.S. Cl. CPC G06Q 10/06393

(57) ABSTRACT

For the purpose of reducing the processing amount in evaluating an effect of a measure with a KPI, a measure evaluation system is configured to have: a basic indicator calculation module grouping data into a subject and a non-subject and calculating basic indicators of the subject and the non-subject before measure execution; a basic indicator estimation module creating, for each basic indicator, an estimation model representing a relationship between the basic indicators of the subject and the non-subject and estimating an estimated basic indicator, which is exhibited when the measure is not executed on the subject, based on a basic indicator of the subject after measure execution and on the estimation model; and a KPI evaluation calculation module receiving a KPI definition formed of arithmetic calculation of basic indicators and calculating an estimated KPI value corresponding to the KPI definition with the KPI definition and the estimated basic indicator.

### BACKGROUND OF THE INVENTION

This invention relates to a measure evaluation system and a measure evaluation method, and more particularly, to a measure effect evaluation system and a measure evaluation method, for evaluating an effect of a measure through use of a KPI.

A method of determining, for example, an influence of a measure that is executed in a business operation based on a KPI formed of various types of information and data is performed in various types of businesses including a distribution business. For example, JP 2002-024471 A describes a technology calculating, based on a similar group, an estimated value exhibited when an event or the like is not held, and comparing the estimated value with an actual value exhibited when an event or the like is held, to thereby grasp a usage state of transportation.

In the technology described in JP 2002-024471 A, a basis for evaluation (KPI) to be used for evaluation is determined, and a similar group having a KPI similar to that of an evaluation subject group is determined. Then, a KPI of the subject group exhibited when an event is not held is estimated based on the similar group, and an actual KPI value of the subject group and the estimated KPI value thereof are compared with each other. However, with this method, when there are a large number of KPIs, processing is required to be repeated as many times as the number of KPIs, and hence an amount of processing increases. Moreover, a similar group having a KPI similar to that of the evaluation subject group is required to be determined every time processing is performed, and hence an amount of processing increases also in this regard.

### SUMMARY OF THE INVENTION

Representative examples of means for solving the problem in one embodiment of this invention are as follows. A measure evaluation system, comprising: a basic indicator calculation module configured to group data into a subject, who is a person to be subjected to a measure, and a non-subject, who is a person inhibited from being subjected to the measure, and to calculate a basic indicator of the subject before execution of the measure and a basic indicator of the non-subject before the execution of the measure; a basic indicator estimation module configured to create, for each basic indicator, an estimation model representing a relationship between the basic indicator of the subject and the basic indicator of the non-subject and to estimate an estimated basic indicator, which is a basic indicator exhibited when the measure is inhibited from being executed on the subject, based on a basic indicator of the subject after the execution of the measure and on the estimation model; and KPI evaluation calculation module configured to receive a KPI definition formed of arithmetic calculation of a plurality of basic indicators and to calculate an estimated KPI value corresponding to the KPI definition through use of the KPI definition and the estimated basic indicator.

A method for evaluating a measure, comprising: a step configured to group data into a subject, who is a person to be subjected to a measure, and a non-subject, who is a person inhibited from being subjected to the measure; a step configured to calculate a basic indicator of the subject before execution of the measure and a basic indicator of the non-subject before the execution of the measure; a step configured to to create, for each basic indicator, an estimation model representing a relationship between the basic indicator of the subject and the basic indicator of the non-subject; a step configured to estimate an estimated basic indicator, which is a basic indicator exhibited when the measure is inhibited from being executed on the subject, based on a basic indicator of the subject after the execution of the measure and on the estimation model; a step configured to receive a KPI definition formed of arithmetic calculation of a plurality of basic indicators; and a step configured to calculate an estimated KPI value corresponding to the KPI definition through use of the KPI definition and the estimated basic indicator.

A representative example of effects of this invention is as follows: the processing amount can be reduced more easily when an effect of a measure is evaluated through use of a KPI.

### BRIEF DESCRIPTIONS OF DRAWINGS

The present invention can be appreciated by the description which follows in conjunction with the following figures, wherein:

FIG. 1 is a diagaram illustrating a system configuration according to Embodiment 1;

FIG. 2 is an example of a screen of an input/output module according to Embodiment 1;

FIG. 3 is an example of a screen of a KPI definition input screen according to Embodiment 1;

FIG. 4 is an example of screen of an evaluation result display screen according to Embodiment 1;

FIG. 5 is an example of a data structure of purchase history data according to Embodiment 1;

FIG. 6 is an example of a data structure of article master data according to Embodiment 1;

FIG. 7 is an example of a data structure of customer information data according to Embodiment 1;

FIG. 8 is an example of a data structure of store information data according to Embodiment 1; and

FIG. 9 is a flowchart illustrating basic indicator calculation processing, a basic indicator estimation processing, and a KPI evaluation calculation processing according to Embodiment 1.

### DETAILED DESCRIPTION OF THE PREFERRED EMBODIMENTS

### Embodiment 1

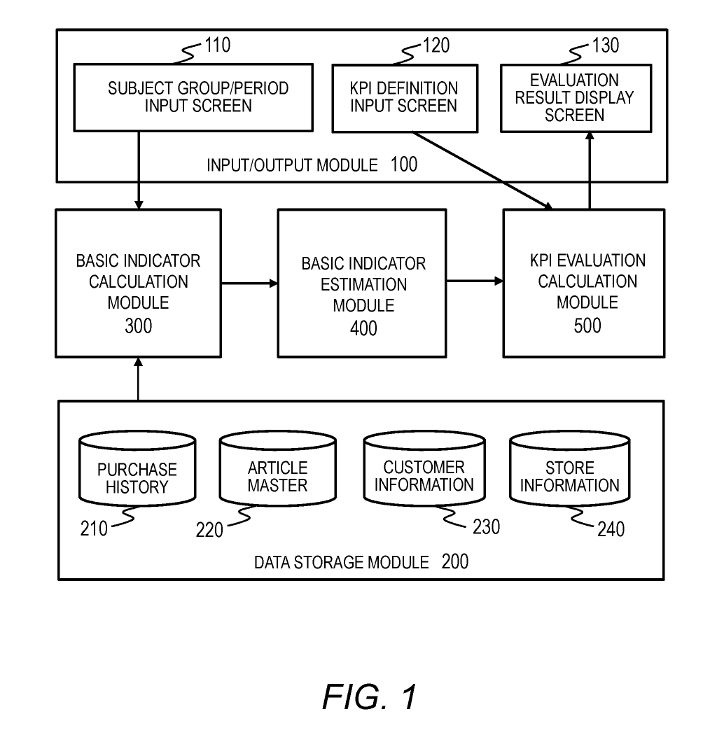

A configuration of a system for evaluating an effect of a distribution measure in Embodiment 1 of this invention is illustrated in FIG. 1. As illustrated in FIG. 1, the system includes an input/output module 100, a data storage module 200, a basic indicator calculation module 300, a basic indicator estimation module 400, and a KPI evaluation calculation module 500. In this invention, a “basic indicator” refers to an indicator, for example, POS data, which is included in a system of a distribution business, and a “KPI” refers to an indicator defined by arithmetic calculation of a plurality of basic indicators.

The input/output module 100, the basic indicator calculation module 300, the basic indicator estimation module 400, and the KPI evaluation calculation module 500 are functional blocks executed by, for example, a CPU (not shown). The input/output module 100 is displayed on an output apparatus, for example, a display (not shown). The data storage module 200 is a database constructed of various types of storage apparatus.

The input/output module 100 includes a subject group/period input screen 110, a KPI definition input screen 120, and an evaluation result display screen 130.

The data storage module 200 includes purchase history data 210, article master data 220, customer information data 230, and store information data 240.

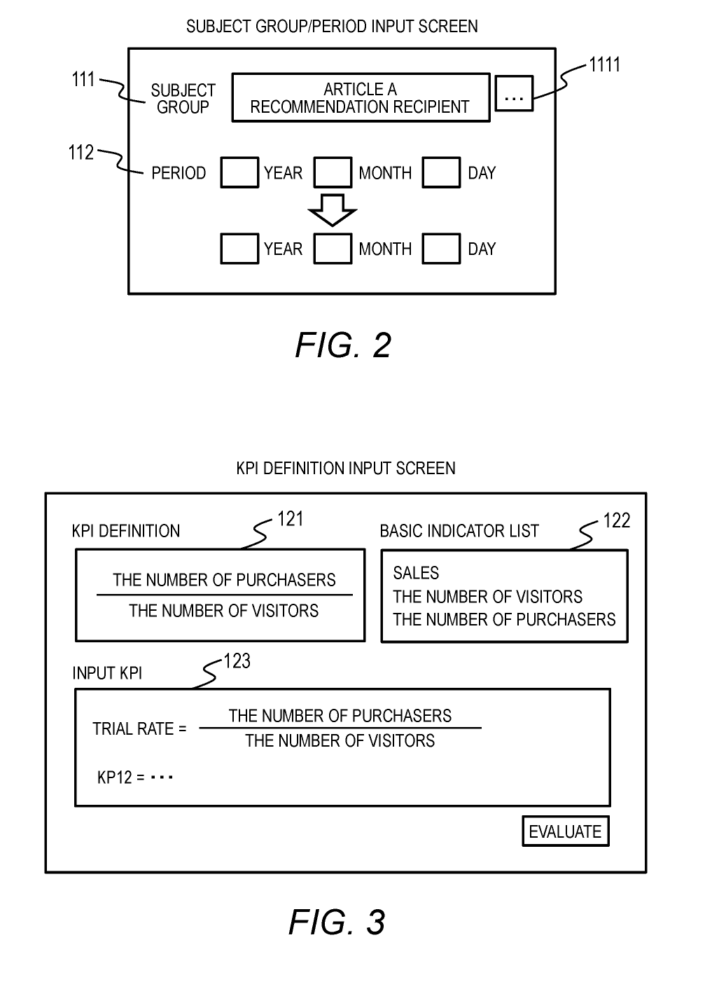

Examples of the screens of the input/output module 100 are described below. An example of the subject group/period input screen 110 is illustrated in FIG. 2. As illustrated in FIG. 2, the subject group/period input screen 110 includes a subject group input field 111 and a period input field 112. When a subject group, which is a group of persons to be subjected to a measure, is to be input, a file selection button 1111 may be used to select and input a file in which a list of subjects is described. Further, when a subject group is to be input, the subject group may be specified based on the age, gender, or other such information on a person to be subjected to the measure. In FIG. 2, “article A recommendation recipient” is selected as an example of the subject group.

An example of the KPI definition input screen 120 is illustrated in FIG. 3. As illustrated in FIG. 3, the KPI definition input screen 120 includes a KPI definition input field 121, a basic indicator list 122, and an input KPI definition list 123. When a KPI definition desired to be calculated is to be input, a basic indicator to be used may be selected from the basic indicator list 122, and a calculation expression for calculation of a KPI may be input to the KPI definition input field 121. In FIG. 3, sales, the number of visitors, and the number of purchasers are used as the basic indicators. Further, a trial rate is input as an example of the KPI. On the KPI definition input screen 120, a plurality of KPI definitions may be input.

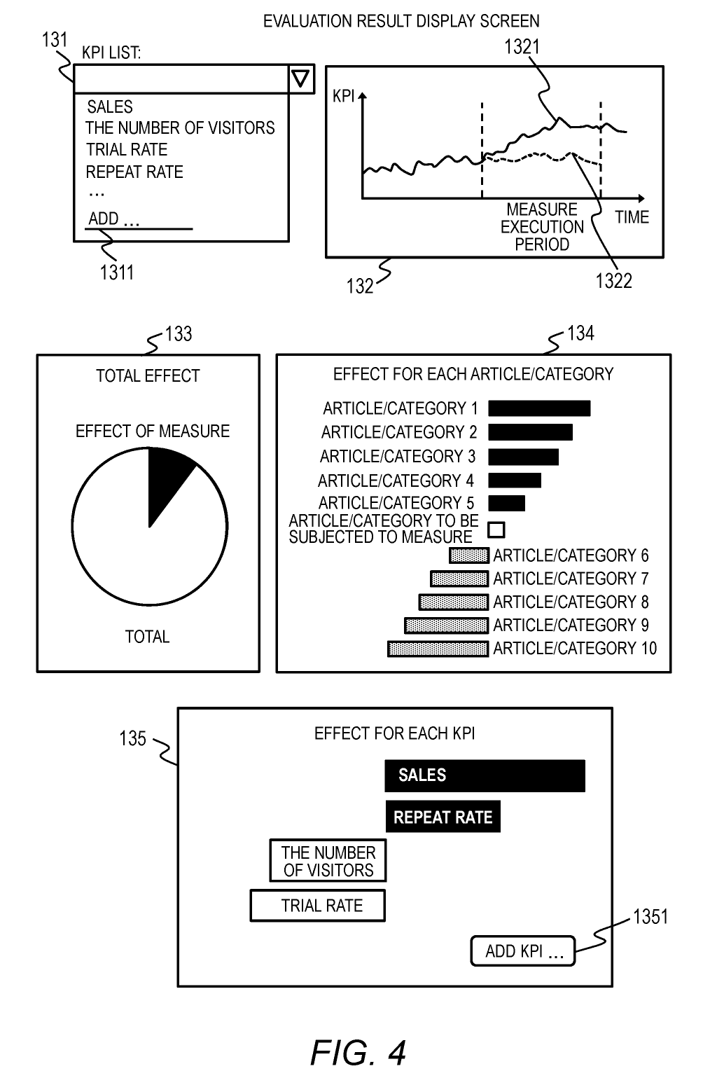

An example of the evaluation result display screen 130 is illustrated in FIG. 4. As illustrated in FIG. 4, the evaluation result display screen 130 includes a KPI list 131, a KPI time series 132, a measure effect 133, an effect for each article/category 134, and an effect for each KPI 135. In the KPI time series 132, an actual KPI value 1321 and an estimated KPI value 1322 exhibited when a measure is not executed are displayed. When a KPI evaluation is to be displayed, a KPI desired to be displayed may be selected from the KPI list 131. Further, an “add” button 1311 or an “add KPI” button 1351 may be used to call the screen of FIG. 3 to additionally input a KPI definition. A specific example of this screen is described later.

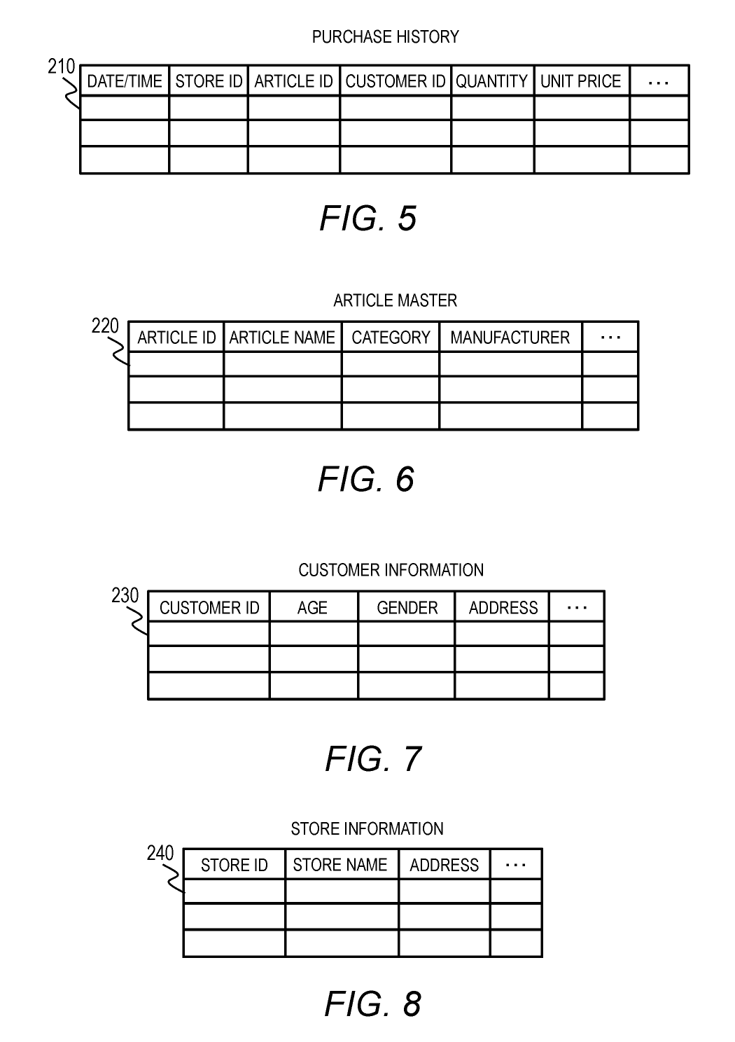

Next, a structure of the data storage module 200 is described with reference to FIG. 5 to FIG. 8. Structures of various kinds of data of FIG. 5 to FIG. 8, which are merely examples, may include other information, and may not include unnecessary information.

A structure example of the purchase history data 210 is shown in FIG. 5. As shown in FIG. 5, the purchase history data 210 includes, for example, date/time data, store ID data, article ID data, customer ID data, quantity data, and unit price data.

A structure example of the article master data 220 is shown in FIG. 6. As shown in FIG. 6, the article master data 220 includes, for example, article ID data, article name data, category data, and manufacturer data.

A structure example of the customer information data 230 is shown in FIG. 7. As shown in FIG. 7, the customer information data 230 includes, for example, customer ID data, age data, gender data, and address data.

A structure example of the store information data 240 is shown in FIG. 8. As shown in FIG. 8, the store information data 240 includes, for example, store ID data, store name data, and address data.

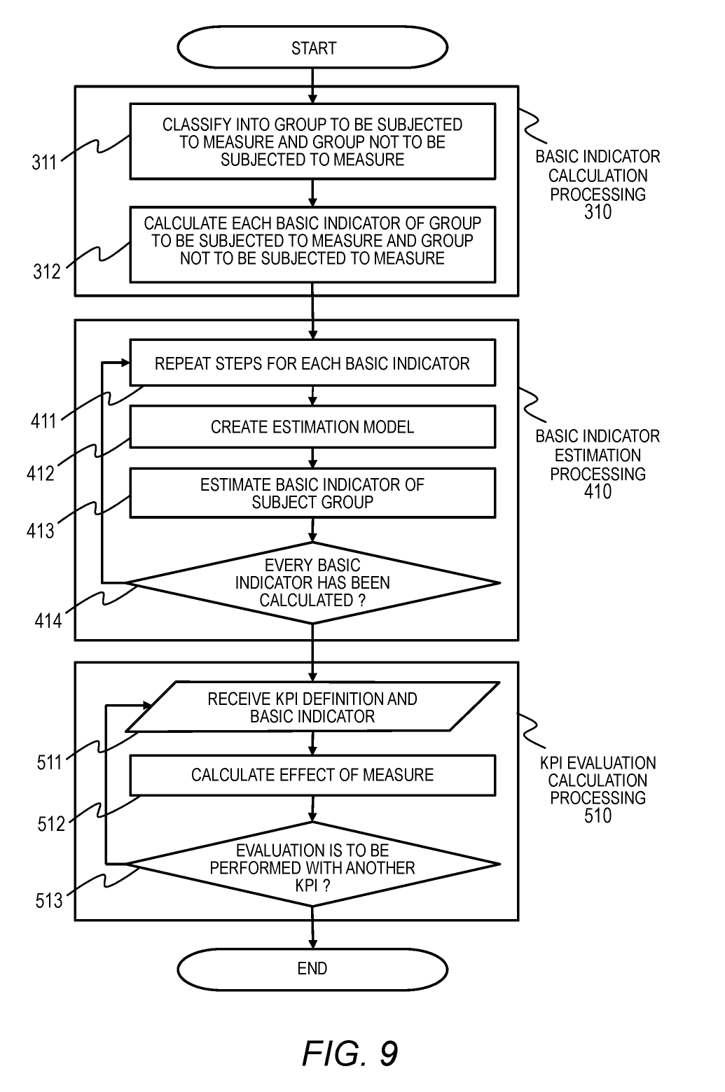

Next, the basic indicator calculation module 300, the basic indicator estimation module 400, and the KPI evaluation calculation module 500 are described with reference to a flowchart of FIG. 9. As illustrated in FIG. 9, processing procedures to be executed by the basic indicator calculation module 300, the basic indicator estimation module 400, and the KPI evaluation calculation module 500 are formed by basic indicator calculation processing 310, basic indicator estimation processing 410, and KPI evaluation calculation processing 510, respectively.

In the basic indicator calculation processing 310, first, data stored in the data storage module 200 is classified into the subject group and a non-subject group, which is a group of persons not to be subjected to the measure based on a subject group definition and a measure execution period, which are input on the input/output module 100 (Step 311). Next, a basic indicator of the subject group before the execution of the measure, a basic indicator of the non-subject group before the execution of the measure, a basic indicator of the subject group during the measure execution period, and a basic indicator of the non-subject group during the measure execution period are calculated for each of the subject group and the non-subject group based on a definition of a basic indicator (Step 312).

In the basic indicator estimation processing 410, an estimation model representing a relationship between the calculated basic indicator of the subject group before the execution of the measure and the calculated basic indicator of the non-subject group before the execution of the measure is created (Step 412). Next, a basic indicator of the subject group exhibited when the measure is not executed during the measure execution period is estimated based on the created estimation model and the basic indicator of the non-subject group during the measure execution period (Step 413).

It should be noted that estimation processing of the basic indicator estimation processing 410 is performed on each basic indicator particularly at the previous stage of the KPI evaluation calculation processing 510 (Step 411 and Step 414). As a result, the loop of the basic indicator estimation processing 410 is only required to be executed as many times as the number of basic indicators, which is at most a few times. Therefore, processing can be performed at high speed. In addition, this processing can be executed before a KPI for which an effect of a measure is to be calculated is determined.

In the KPI evaluation calculation processing 510, first, a KPI definition input on the input/output module 100, the basic indicator of the subject group during the measure execution period, which is calculated in the basic indicator calculation processing 310, and the basic indicator of the subject group exhibited when the measure is not executed during the measure execution period, which is estimated in the basic indicator estimation processing 410, are received (Step 511). Next, an actual KPI value of the subject group during the measure execution period and an estimated KPI value of the subject group exhibited when the measure is not executed during the measure execution period are calculated based on the received KPI definition and basic indicators. Then, the estimated KPI value of the subject group exhibited when the measure is not executed during the measure execution period is subtracted from the actual KPI value of the subject group during the measure execution period, to thereby calculate an effect of the measure (Step 512). The calculated effect of the measure is displayed on the evaluation result display screen 130.

It should be noted that this processing is performed on a KPI definition after the KPI definition input by a user is received. In the technology described in JP 2002-024471 A, a basis for evaluation (KPI) is defined in advance, and creation of a model expression, calculation of an estimated value, and the like are performed with respect to the KPI. However, in general, a large number of KPIs can be generated from combinations of basic indicators, and hence when estimation processing is performed for each KPI, a load of calculation becomes disadvantageously enormous. Moreover, unless a KPI for which the estimation processing is to be performed is known in advance, unnecessary calculation is required to be performed. In contrast, in this processing, the estimation processing for basic indicators has already been completed in the basic indicator estimation processing 410. Thus, through use of the estimated basic indicators, the calculation of an effect of a measure with respect to a KPI specified by the user can easily be completed, and the amount of calculation can thus be suppressed. In addition, even when a KPI is added as required by the user, an effect of a measure corresponding to the added KPI can be calculated as needed (Step 513).

Referring back to FIG. 4, specific details of each section of display are described. In FIG. 4, effects of the measure exhibited by the recommendation of the article A are displayed. In the KPI list 131, KPIs that can be evaluated are displayed. Of the KPIs, an effect on sales is displayed in the KPI time series 132. An actual value of sales (actual KPI value) 1321 and estimated sales (estimated KPI value) 1322 exhibited when the measure of recommendation of the article A is not executed are displayed. Further, in the measure effect 133, a proportion of the effect of the measure of recommendation of the article A to the total sales is displayed. Further, in the effect for each article/category 134, the category of the article A, five categories whose sales have increased due to the influence of the measure of recommendation of the article A, and five categories whose sales have decreased due to the influence of the measure of recommendation of the article A are displayed. Further, in the effect for each KPI 135, an influence of the measure of recommendation of the article A on each KPI is displayed. During an operation for evaluation, the “add” button 1311 or the “add KPI” button 1351 may be used to call the screen of FIG. 3 to newly add a KPI definition for quick evaluation.

### EXPLANATION OF REFERENCES

100 input/output module
110 a subject group/period input screen
111 subject group input field
112 period input field
120 KPI definition input screen
121 KPI definition input field
122 basic indicator list
123 input KPI definition list
130 evaluation result display screen
131 KPI list
132 KPI time series
133 measure effect
134 effect for each article/category
135 effect for each KPI
200 data storage module
210 purchase history data
220 article master data
230 customer information data
240 store information data
300 basic indicator calculation module
310 basic indicator calculation processing
400 basic indicator estimation module
410 basic indicator estimation processing
500 KPI evaluation calculation module
510 KPI evaluation calculation processing
1111 a file selection button
1311 add button
1321 actual KPI value
1322 estimated KPI value
1351 add KPI button

What is claimed is:

1. A measure evaluation system, comprising:
a basic indicator calculation module configured to group data into a subject, who is a person to be subjected to a measure, and a non-subject, who is a person inhibited from being subjected to the measure, and to calculate a basic indicator of the subject before execution of the measure and a basic indicator of the non-subject before the execution of the measure;
a basic indicator estimation module configured to create, for each basic indicator, an estimation model representing a relationship between the basic indicator of the subject and the basic indicator of the non-subject and to estimate an estimated basic indicator, which is a basic indicator exhibited when the measure is inhibited from being executed on the subject, based on a basic indicator of the subject after the execution of the measure and on the estimation model; and
a KPI evaluation calculation module configured to receive a KPI definition formed of arithmetic calculation of a plurality of basic indicators and to calculate an estimated KPI value corresponding to the KPI definition through use of the KPI definition and the estimated basic indicator.

2. The measure evaluation system according to claim 1, wherein the KPI evaluation calculation module is further configured to calculate an actual KPI value corresponding to the KPI definition through use of the KPI definition and the basic indicator of the subject after the execution of the measure to calculate an effect of the measure through use of the estimated KPI value and the actual KPI value.

3. A method for evaluating a measure, comprising:
a step configured to group data into a subject, who is a person to be subjected to a measure, and a non-subject, who is a person inhibited from being subjected to the measure;
a step configured to calculate a basic indicator of the subject before execution of the measure and a basic indicator of the non-subject before the execution of the measure;
a step configured to to create, for each basic indicator, an estimation model representing a relationship between the basic indicator of the subject and the basic indicator of the non-subject;
a step configured to estimate an estimated basic indicator, which is a basic indicator exhibited when the measure is inhibited from being executed on the subject, based on a basic indicator of the subject after the execution of the measure and on the estimation model;
a step configured to receive a KPI definition formed of arithmetic calculation of a plurality of basic indicators; and
a step configured to calculate an estimated KPI value corresponding to the KPI definition through use of the KPI definition and the estimated basic indicator.

4. The method for evaluating a measure according to claim 3 system, wherein the step caldulating the estimated KPI value configured to calculate an actual KPI value corresponding to the KPI definition through use of the KPI definition and the basic indicator of the subject after the execution of the measure to calculate an effect of the measure through use of the estimated KPI value and the actual KPI value.
